(19) United States
(12) Patent Application Publication
(10) Pub. No.: US 2020/0221278 A1
(43) Pub. Date: Jul. 9, 2020

(54) EMERGENCY ALERT SYSTEM

(71) Applicant: Salutec IP, LLC, Solana Beach, CA (US)

(72) Inventors: Srinivasan Balasubramanian, San Diego, CA (US); Jimmy Anklesaria, Del Mar, CA (US)

(21) Appl. No.: 16/736,751

(22) Filed: Jan. 7, 2020

Related U.S. Application Data
(60) Provisional application No. 62/790,368, filed on Jan. 9, 2019.

(51) Int. Cl. H04W 4/90; H04W 4/029; H04W 76/50; H04W 4/80; G08B 25/01

(52) U.S. Cl. CPC H04W 4/90; H04W 4/029; G08B 25/016; H04W 4/80; H04W 76/50

(57) ABSTRACT

An emergency alert system is disclosed that includes a card, a device and a central server. The card has an activation button, a Bluetooth transmitter that transmits a beacon that includes a unique identification for the card and the current card state. A controller is connected to the button and transmitter, and perform the following steps: transmits a beacon identifying the current state as normal when the activation button is not actuated, and transmits a beacon identifying the current state as emergency when the activation button is actuated. The device includes a Bluetooth receiver that receives the beacon, a communications port, and a device controller that performs the following steps: receive and process the beacon and transmit an emergency signal on the communications port when the beacon is in an emergency state. The central server is connected to the communications port and receives the emergency signal.

### 1.0 RELATED APPLICATIONS

This application claims priority as the non-provisional of U.S. Application 62/790,368 filed on Jan. 9, 2019 the contents of which are incorporated herein by reference.

### 2.0 TECHNICAL FIELD

The present invention relates generally to a system for identifying an emergency and summoning help for the same.

### 3.0 BACKGROUND

With a rising incidence of violence on school campuses and in densely populated areas, such as attacks, stalking, and active shooters, there is increasing need for a portable and easy-to-use emergency alert device to get help to the user's location.

In the prior art, emergency alert systems such as U.S. Pat. No. 7,983,654 to Shelton et al., which utilized emergency alert pagers to send out mass alerts, relied heavily on text input by the user. However, this is not practical for a user attempting to alert the proper emergency response channels while the user is on the move, such as fleeing from the scene of an active shooting or while trying to evade a stalker.

There are some instances of emergency alert systems that would automatically detect an emergency without input from the user, such as on behalf of an unconscious driver who had a car accident. U.S. Pat. No. 7,181,192 to Panasik et al. discloses such an emergency alert system, but its scope is rather narrow, and the automatic sensor only detects acceleration events.

What is needed, therefore, is a more flexible and easy-to-use emergency alert system the user may operate even while moving. The user may select different types of emergencies, and the emergency alert system would report the real-time location of the user to emergency responders based on the type of emergency situation.

As another point of added flexibility, in the absence of portable devices, such as if a user had to leave a cellular phone behind while fleeing an attack, the location employing the emergency alert system may have stationary devices to receive the beacon, which can be identified by a central server to obtain a preset location data (such as building, floor, and room). Such a system, if widely used, can ensure quick response to medical emergency and crimes, and can enhance safety.

### 4.0 SUMMARY

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

An emergency alert system is disclosed that includes a card, a device and a central server. The card has an activation button, a Bluetooth transmitter that transmits a beacon that includes a unique identification for the card and the current card state. A controller is connected to the button and transmitter, and perform the following steps: transmits a beacon identifying the current state as normal when the activation button is not actuated, and transmits a beacon identifying the current state as emergency when the activation button is actuated. The device includes a Bluetooth receiver that receives the beacon, a communications port, and a device controller that performs the following steps: receive and process the beacon and transmit an emergency signal on the communications port when the beacon is in an emergency state. The central server is connected to the communications port and receives the emergency signal.

The beacon may include a battery state, and the device comprises a display or a sound device, and the device controller actuates the display or sound device when the beacon is in a low battery state.

The card may include an illumination device that is actuated when the activation button is actuated. The activation button may be actuated by either pressing the button for longer than five seconds or pressing the button five or more times within four seconds. The card may include a housing that houses the activation button, the Bluetooth transmitter, the controller and the illumination device.

The device may be one or more cellular phones, and the communications port for the one or more cellular phones may be wireless. The cellular phone may include an emergency application that allows a user to select a type of emergency, and the device controller is configured to perform the following steps: open the emergency application when the beacon is in an emergency state; receive the input from the user selecting the type of emergency; and the emergency signal further comprises the type of emergency selected by the user. The application may automatically indicate the type of emergency as police if the user does not select the type of emergency within a pre-selected time period. The application may allow the user to select from the following emergencies: police, fire, medical, chemical leak, and, vehicular crash. The device controller may be configured to perform the following steps: determine the location of the cellular phone; and the emergency signal further comprises the location of the cellular phone.

The central server may transmit to the cellular phone a confirmation signal that the emergency signal has been received, and a display or speaker of the cellular device is triggered based on the confirmation signal. Upon receipt of the confirmation signal, the cellular phone opens a dialog session with the central server.

The device comprises one or more Bluetooth readers that are relatively fixed to a particular location and have unique identifiers. The location of the one or more Bluetooth readers and their associated unique identifiers are stored within the system and the emergency signal includes the Bluetooth reader's unique identifier and the central server looks up the location of the Bluetooth reader's unique identifier.

Additional aspects, alternatives and variations, as would be apparent to persons of skill in the art, are also disclosed herein and are specifically contemplated as included as part of the invention. The invention is set forth only in the claims as allowed by the patent office in this or related applications, and the following summary descriptions of certain examples are not in any way to limit, define or otherwise establish the scope of legal protection.

### 5.0 BRIEF DESCRIPTION OF THE DRAWINGS

The invention can be better understood with reference to the following figures. The components within the figures are not necessarily to scale, emphasis instead being placed on clearly illustrating example aspects of the invention. In the figures, like reference numerals designate corresponding parts throughout the different views and/or embodiments. It will be understood that certain components and details may not appear in the figures to assist in more clearly describing the invention.

FIG. 1 illustrates an emergency alert system.

FIG. 2 illustrates the card used in the emergency alert system of claim 1.

FIG. 3 illustrates a cellular phone used as the device to receive the Bluetooth beacon from the card.

FIG. 4 illustrates a Bluetooth reader used as the device to receive the Bluetooth beacon from the card.

FIG. 5 is a flowchart illustrating the processing within the card to transmit an emergency state beacon.

FIG. 6 is a flowchart illustrating the processing within the device (cellular phone) to receive an emergency state beacon and transmit the emergency signal (including location information) to the central server, thereby opening a dialog session.

FIG. 7 is a flowchart illustrating the processing within the device (Bluetooth reader) to receive an emergency state beacon and transmit the emergency signal to the central server, and the central server determining the location of the reporting Bluetooth reader.

FIG. 8 is a flowchart illustrating the operation of the application that allows a user to select a type of emergency.

### 6.0 DETAILED DESCRIPTION OF EXAMPLE EMBODIMENTS

Reference is made herein to some specific examples of the present invention, including any best modes contemplated by the inventor for carrying out the invention. Examples of these specific embodiments are illustrated in the accompanying figures. While the invention is described in conjunction with these specific embodiments, it will be understood that it is not intended to limit the invention to the described or illustrated embodiments. To the contrary, it is intended to cover alternatives, modifications, and equivalents as may be included within the spirit and scope of the invention as defined by the appended claims.

In the following description, numerous specific details are set forth in order to provide a thorough understanding of the present invention. Particular example embodiments of the present invention may be implemented without some or all of these specific details. In other instances, process operations well known to persons of skill in the art have not been described in detail in order not to obscure unnecessarily the present invention. Various techniques and mechanisms of the present invention will sometimes be described in singular form for clarity. However, it should be noted that some embodiments include multiple iterations of a technique or multiple mechanisms unless noted otherwise. Similarly, various steps of the methods shown and described herein are not necessarily performed in the order indicated, or performed at all in certain embodiments. Accordingly, some implementations of the methods discussed herein may include more or fewer steps than those shown or described. Further, the techniques and mechanisms of the present invention will sometimes describe a connection, relationship or communication between two or more entities. It should be noted that a connection or relationship between entities does not necessarily mean a direct, unimpeded connection, as a variety of other entities or processes may reside or occur between any two entities. Consequently, an indicated connection does not necessarily mean a direct, unimpeded connection unless otherwise noted.

The following list of example features corresponds with attached figure and is provided for ease of reference, where like reference numerals designate corresponding features throughout the specification and figures:

| | |
|---|---|
| System | 10 |
| Card | 15 |
| Beacon | 12 |
| Device (Cellular Phones) | 20 |
| Device (Bluetooth Reader) | 25 |
| Emergency Signal (wireless) | 30 |
| Emergency Signal (wired) | 32 |
| Central Server | 35 |
| Cellular Tower | 40 |
| Internet Access Point | 45 |
| Confined Area | 50 |
| Activation Button | 55 |
| Bluetooth Transmitter | 60 |
| Controller | 65 |
| Illumination Device | 70 |
| Card Housing | 75 |
| Bluetooth Receiver | 80 |
| Communications Port | 85 |
| Device Controller | 90 |
| Steps of processing within the card | 501-507 |
| Steps of processing within a portable (cellular phone) device | 600-655 |
| Steps of processing within a Bluetooth reader device | 700-755 |
| Steps of operating the device application to select | 800-840 |
| emergency type | |

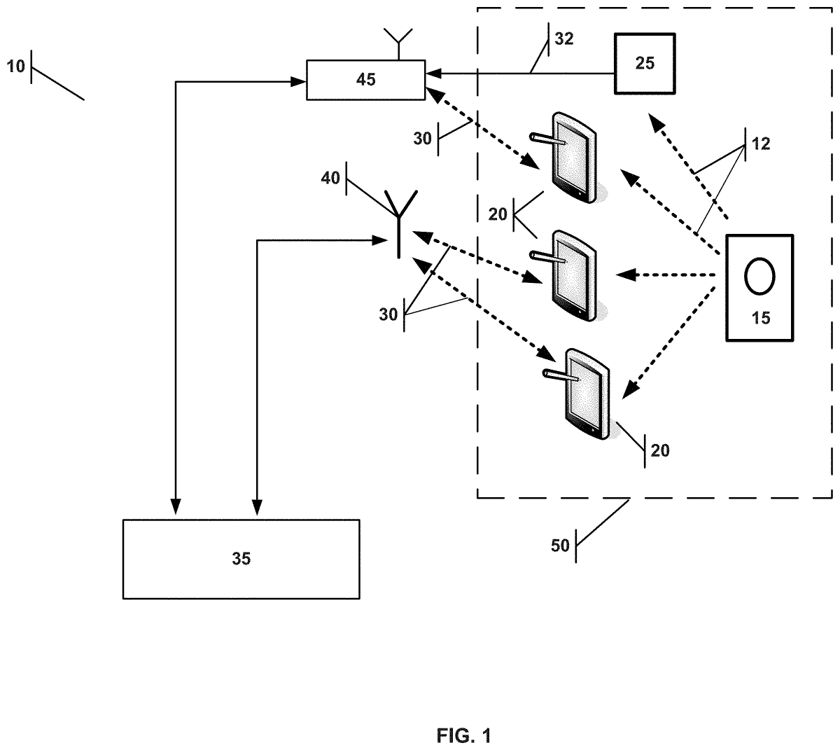

With reference to FIG. 1, the present invention provides an emergency alert system 10 wherein a portable card 15 interacts with a device 20 or 25 and a central server 35. The card 15 may transmit a Bluetooth beacon 12 to a device 20 or 25, and the device 20 or 25 then sends the emergency signal 30 or 32 to a central server 35, which may be in communication with the device 20 or 25 using an internet access point 45 and the internet, and/or the cell tower 40 and the cellular network. In FIG. 1, the beacon 12 issued by the card 15 may reach a Bluetooth reader device 25 that has a wired connection to an internet access point 45 and can send a wired emergency signal 32. The beacon 12 issued by the same card 15 may also reach a portable, cellular phone type device 20, which may then send a wireless emergency signal 30 that can be routed to a central server 35 either via the cell tower 40 or internet access point 45. The confined area 50 refers to the vicinity where the card 15 was used to broadcast the beacon 12 to indicate an emergency.

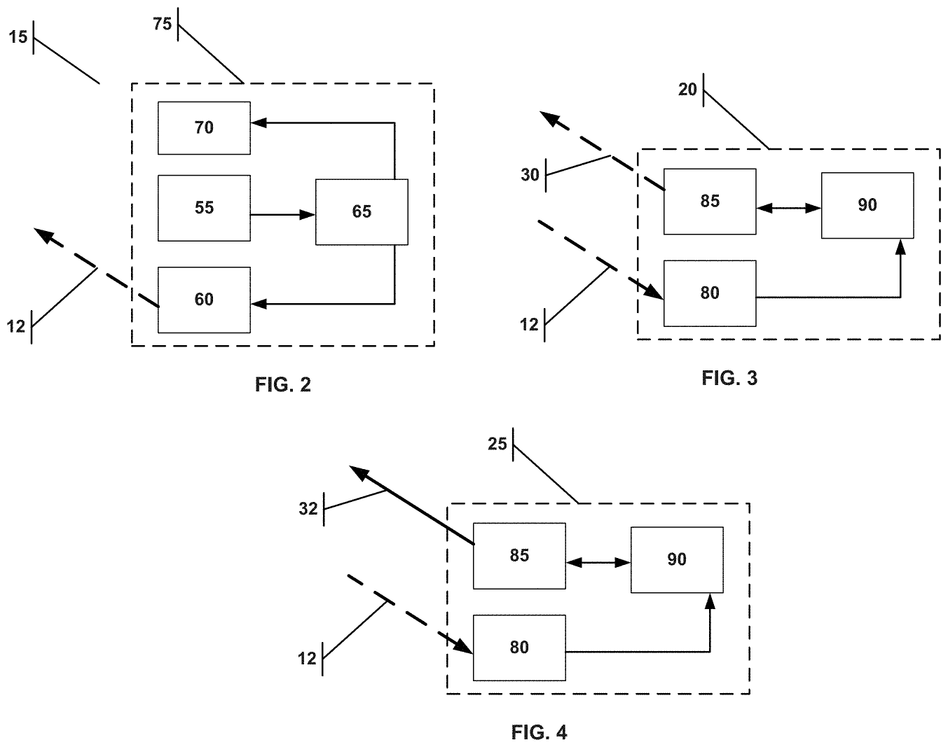

The card 15 is illustrated in more detail in FIG. 2. The card 15 comprises an activation button 55, a Bluetooth transmitter 60 configured to transmit a beacon 12, and a controller 65, which is connected to the activation button 55 and the Bluetooth transmitter 60. The beacon 12 comprises, at a minimum, a unique identification for the card 15 and a current card state. The controller 65 is configured to transmit a beacon 12 identifying the current state as normal when the activation button 55 is not actuated (or when the button 55 has not been actuated for at least the duration of an emergency time period) and is configured to transmit a beacon 12 identifying the current state as emergency when the activation button is actuated (or when the button 55 has just been actuated within the duration of a predetermined emergency time period). As shown in FIG. 2, the card 15 may also comprise an illumination device 70, wherein the illumination device 70 is actuated when the activation button 55 is actuated. The activation button 55 may be actuated by pressing the button 55 in a predefined pattern. Such a pattern might be, for example, pressing the button 55 for longer than five seconds or pressing the button 55 five or more times within four seconds, or three or more times within three seconds. The card 15 may also comprise a card housing 75, which houses the activation button 55, the Bluetooth transmitter 60, the card controller 65, and the illumination device 70.

In FIG. 3, the portable (cell phone) device 20 that receives the beacon 12 from the card 15 is shown in detail. The device 20 comprises a Bluetooth receiver 80 configured to receive the beacon 12 transmitted by the card 15, a communications port 85, and a device controller 90 connected to the Bluetooth receiver 80 and to the communications port 85, wherein the device controller 90 is configured to receive and process the beacon 12, and to transmit an emergency signal 30 on the communication port 85 when the beacon 12 indicates an emergency state. Note that in the emergency alert system 10 of the present invention, the device may comprise one or more cellular phones 20, and the communications port(s) 85 for the one or more cellular phones is wireless, when the wireless emergency signal 30 is transmitted via the communications port 85. The device controller 90 on the device 20 may be configured to determine the location of the cellular phone 20, and include the location of the cellular phone 20 as part of the emergency signal 30 that it transmits via the communications port 85.

A central server 35 also connects to the communications port 85, and is configured to receive the emergency signal 30. The central server 35 can transmit to the cellular phone 20, either via the cell tower 40 or via the internet access point 45, a confirmation signal that the emergency signal 30 has been received. The central server 35 may then process the emergency signal 30 and contact the appropriate emergency responders. When the cellular phone 20 receives the confirmation signal from the central server 35, a display or a speaker of the cellular device 20 may be triggered based on the confirmation signal, to provide an indication to the user that the emergency signal 30 was received by the server 35. Upon receipt of the confirmation signal, the cellular phone 20 may optionally open a dialog session with the central server 35, so that the user, if able to do so, may be able to provide more information regarding the emergency and/or the user's location to the central server 35.

The cellular phone 20 in the emergency alert system 10 may also comprise an emergency application that allows a user to select a type of emergency, so that the emergency signal 30 can be routed to the appropriate channels and responders. The controller 90 on the device 20 may be configured to perform the following: open the emergency application when the beacon 12 is in an emergency state, and receive the input from the user selecting the type of emergency. Then, the emergency signal 30 transmitted to the central server 35 may include the type(s) (more than one may be selected) of emergency. The device 20 may transmit the emergency signal 30 multiple times for each type of emergency the user selects or may transmit the emergency type selected in the same dialog session with the central server 35; these are obvious variations that do not depart from the spirit and scope of the present invention. The types of emergencies the user may select from can include, as non-limiting examples, police, fire, medical, chemical leak, and vehicle crash. If the user does not select the type of emergency within a pre-selected time period, the application automatically indicates a default type of emergency, such as police. In addition, the emergency application may also be configured to indicate when the card 15 has low battery status. The beacon 12 may comprise information indicating a battery state, and the device 20 may comprise a display or a sound device; the device controller 90 would be able to actuate the display or sound device when the beacon 12 is in a low battery state. For example, when the application on the device 20 detects a low battery state in the beacon 12, it may provide a pop-up notification to charge the card 15, and/or display a Low Battery indicator on the device 20.

The emergency alert system 10 may also work with wired devices 25, such as Bluetooth readers; the device may comprise one or more Bluetooth readers 25 that are relatively fixed to a particular location and have unique identifiers. By relatively fixed, it is meant that such a device 25 may be located within a certain room or space and may be moved around this particular room, but is confined to that room and is not expected to leave that room. These Bluetooth readers 25 do not have GPS sensors and therefore cannot provide real-time location information as the user moves, but because they are relatively fixed (installed in a particular room on a particular floor inside a particular building, for instance), the emergency alert system 10 may store and retrieve this location information to provide to emergency responders based on the device 25's unique identifiers.

When working with Bluetooth readers 25, the communications port 85 transmits wired emergency signals 32 instead of wireless emergency signals 30. The location of the one or more Bluetooth readers 25 and their associated unique identifiers are stored within the system 10, perhaps at a memory location that can be access via cloud computing, as a non-limiting example. The emergency signal 32 transmitted by the Bluetooth readers 25 would then include each Bluetooth reader's unique identifier. The central server 35 could look up the location of the Bluetooth readers 25 and pass that information on to the emergency responders.

As a non-limiting example, the Bluetooth reader 25 might be an iBeacon, a product that helps in identifying a micro-location using at least three customizable values: Proximity UUID (128 bit), Major and Minor values (16 bit each). An iBeacon uses Bluetooth Low Energy technology, sending out a very low power signal that has a very small payload, which allows the card 15 to save power and for the emergency alert system 10 to be robust, cost-effective, and easy-to-use. For example, in an exemplary example, the card has dimensions of 90 mm×61 mm×6.7 mm and includes two 3V CR2430 batteries, which can last for a full year of service, including 25 emergency triggers and regular operation is non-emergency mode. A relatively fixed device 25 in the emergency alert system 10 may include one or more iBeacon devices, and one or more of the customizable values broadcast by an iBeacon to identify itself may be used to indicate or transmit the emergency status of the card 15 and/or the low battery status of the card 15. The iBeacon device may also feature an additional Internal Identifier for identification to the central server 35.

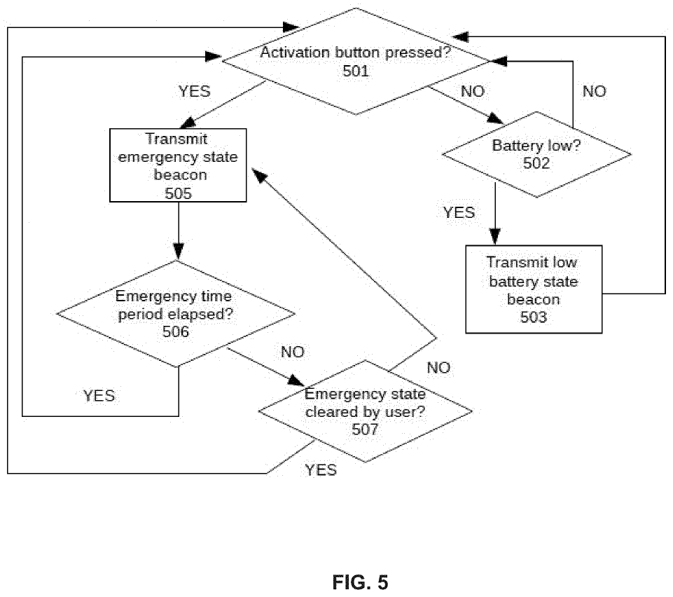

FIG. 5 shows in flow chart form the processing that occurs in the card controller 65. The controller 65 continually detects whether the activation button 55 has been pressed in the correct pattern to actuate an emergency state (step 501). If the activation button 55 has been actuated correctly, the controller 65 has the card 15 transmit a Bluetooth emergency state beacon 12 (step 505) via the Bluetooth transmitter 60. The step of actuating the illumination device 70 to light up can be performed immediately before or immediately after step 505 as an optional step. When the card 15 has transmitted an emergency state beacon in step 505, it may continue to transmit the emergency state beacon until a preset emergency time period has elapsed (506) or until the emergency state has been cleared by the user using the activation button 55, using another set of predetermined patterns to deactivate the card 15. If at step 501 the activation button 55 has not been correctly actuated, then the card controller 65 can determine whether the battery is low in step 502 and transmit the low battery state beacon to the device in step 503.

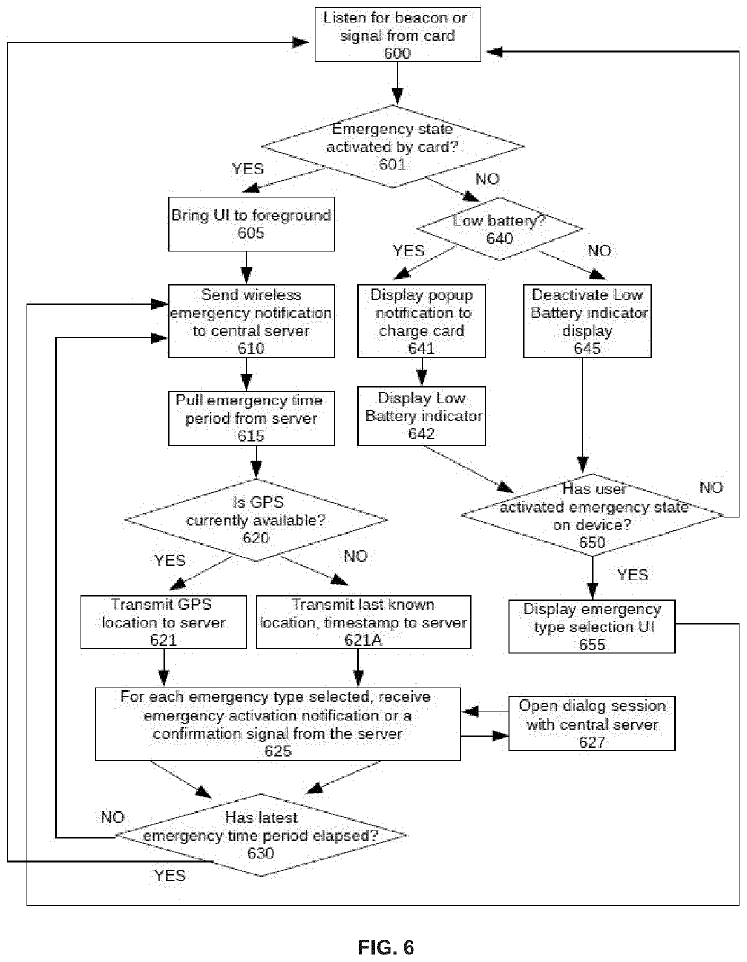

FIG. 6 details the steps and decisions that can be performed by the device controller 90 of the cellular phone 20 in the emergency application previously described. It should be noted that many of these steps may be considered optional and not performed without departing from the spirit and scope of this invention. The controller 90 first listens for the beacon 12 from the card 15 (step 600). It then determines in step 601 whether the beacon indicates an emergency state. If the beacon 12 indicates an emergency state, the device controller 90 would bring the emergency application UI to the foreground of the device 20's operating system, step 605. Next, it can communicate with the central server 35.

The device controller 90 can, as illustrated, send the emergency notification first before transmitting location information provided by a GPS sensor on the device 20 (step 610). It may pull a predefined emergency time period from the server 35 as an optional step 615. It may then determine whether GPS information is current (step 620). If the GPS is currently available, the device 20 transmits the current GPS location of the device 20 to the central server 35 (step 621). If the GPS is not currently available, then the device 20 transmits the last known location and timestamp to the central server 35 (step 621A). It should be noted that steps 610 and 621 or 621A may occur simultaneously or separately without departing from the spirit and scope of the present invention. The device controller then examines the emergency types selected by the user (if any), in the step 625. There will be at least one emergency type transmitted, either whatever the user selects, or, if the user has not selection any emergency type, the device 20 will transmit a default emergency type of police, so that the central server 35 may notify the police of the emergency event. The device 20 will wait for an emergency activation notification (confirmation signal) from the central server 35 in the step 625 for each emergency type selected, and it may at the same time open and use a dialog session with the central server 35 (step 627). Also, in step 625, the device 20 may trigger a display or a speaker to provide a visual and/or an auditory indication to the user that the confirmation signals were received by the central server 35. Optionally, the device controller 90 may be programmed to loop and continue to transmit the emergency signal 30 to the central server 35 until some predetermined emergency time period has elapsed.

If the device 20 does not detect an emergency state beacon from the card 15, it can check to see if the beacon 12 indicates low battery in step 640, and optionally display a popup notification in step 641 and/or display a low battery indicator via the emergency application. If the battery is not low, there is provided the step 645 to deactivate the low battery indicator display, which may be used if say, the battery on the card 15 had previously been low but has just charged up to a level that is not considered low anymore. Also, regardless of the battery level status, even if there was no emergency state activated by the card, the user has the option to activate an emergency state using the device 20 directly. The device controller 90 checks for this in step 650, and if the user has indeed activated an emergency state through the emergency application, the controller 90 then displays the emergency type selection UI for the user to provide more input, and the next step would be step 610, to send a wireless emergency signal 30 to central server 35.

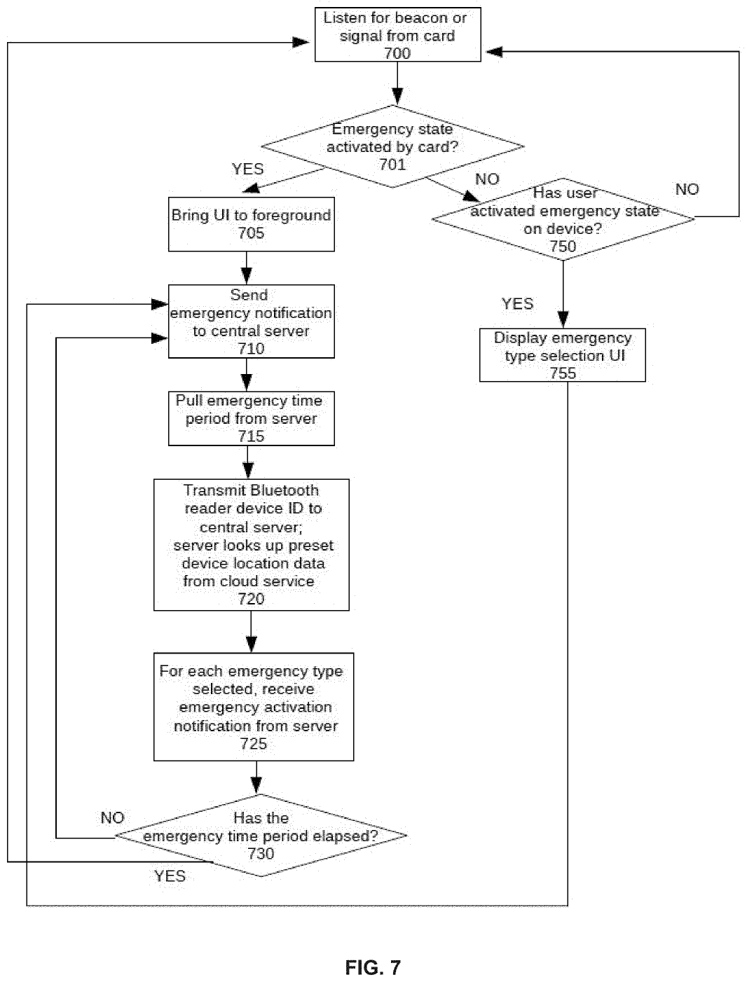

FIG. 7 details the steps and decisions that can be performed by the device controller 90 of the Bluetooth reader 25. It should be noted that many of these steps may be considered optional and not performed without departing from the spirit and scope of this invention. The controller 90 first listens for the beacon 12 from the card 15 (step 700). It then determines in step 701 whether the beacon indicates an emergency state. If the beacon 12 indicates an emergency state, the device controller 90 would bring the emergency application UI to the foreground of the device 25's operating system, step 705. Next, it can communicate with the central server 35.

The device controller 90 can, as illustrated, send the emergency notification first before transmitting location information provided by a GPS sensor on the device 20 (step 710). It may pull a predefined emergency time period from the server 35 as an optional step 715. It may then transmit the Bluetooth reader 25's unique identifiers to the central server 35, step 720, and the server 35 can lookup up the location data from the emergency alert system 10. Although it may be preferable to have the device location data stored over a cloud service, many variations may be possible, and the mention of cloud service in step 720 should not be considered a limiting detail. It should be noted that steps 710 and 720 may occur simultaneously or separately without departing from the spirit and scope of the present invention. The device controller 90 will then examines the emergency types selected by the user (if any), in the step 725. There will be at least one emergency type transmitted, either whatever the user selects, or, if the user has not selection any emergency type, the device 25 will transmit a default emergency type of police, so that the central server 35 may notify the police of the emergency event. The device 25 will wait for an emergency activation notification (confirmation signal) from the central server 35 in the step 625 for each emergency type selected. Optionally, the device controller 90 may be programmed to loop and continue to transmit the emergency signal 32 to the central server 35 until some predetermined emergency time period has elapsed.

If the device 25 does not detect an emergency state beacon from the card 15, the user has the option to activate an emergency state using the device 25 directly. The device controller 90 checks for this in step 750, and if the user has indeed activated an emergency state through the emergency application on the device 25, the controller 90 then displays the emergency type selection UI for the user to provide more input, and the next step would be step 710, to send an emergency signal 32 to the central server 35. It is assumed that steps equivalent to 640, 641, 642, and 645 may optionally be implemented for the relatively fixed device 25, although in FIG. 7 they are not shown for the sake of clarity.

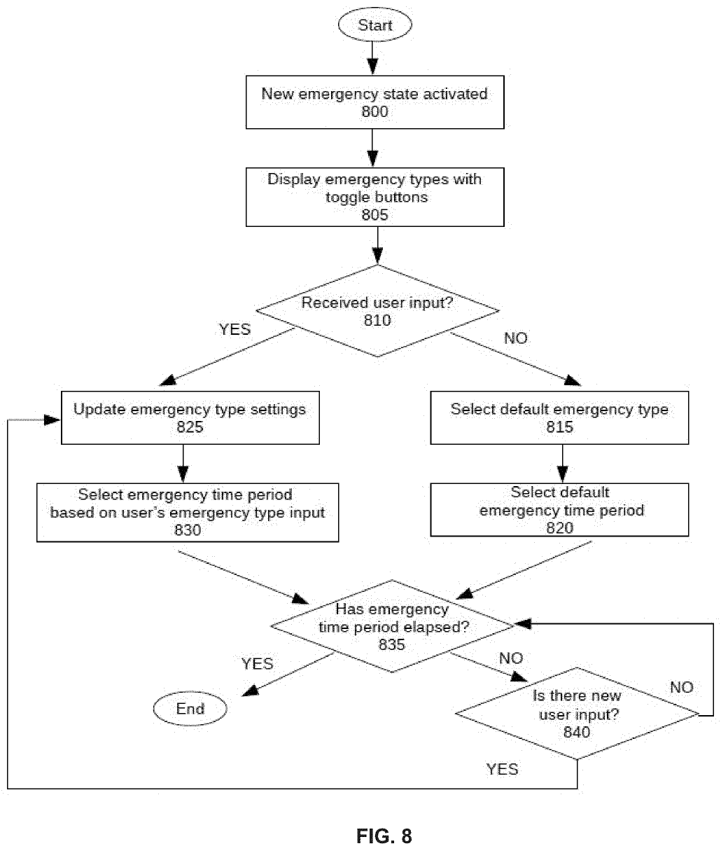

Finally, FIG. 8 provides a flowchart representing one possible implementation of the emergency type selection on the emergency application. When there is detection of a new emergency state activated (step 800), the application may display emergency types on the application screen with toggle buttons (step 805). The application then determines if the user has provided input through the application on what type of emergency occurred (step 810). If the user has not provided any input as to emergency type, the application will select the default emergency type in step 815. This may be, as discussed previously, police. If the user has made selections on the application UI, the application then updates the emergency type settings in step 825, and keep the settings the user has input until there is newer user input (step 840).

Note that the use of a preset emergency time period is optional, as are steps 820 and 830 as well as step 835. It is stated in the provisional application that every time a new emergency type is selected, the emergency time period can be reset. The purpose of using an emergency time period is to make use of redundancy in transmitting the emergency signal, and ensure that the emergency signal 30 or 32 is received by the central server 35 instead of only transmitting it once.

The invention has been described in connection with specific embodiments that illustrate examples of the invention but do not limit its scope. Various example systems have been shown and described having various aspects and elements. Unless indicated otherwise, any feature, aspect or element of any of these systems may be removed from, added to, combined with or modified by any other feature, aspect or element of any of the systems. As will be apparent to persons skilled in the art, modifications and adaptations to the above-described systems and methods can be made without departing from the spirit and scope of the invention, which is defined only by the following claims. Moreover, the applicant expressly does not intend that the following claims “and the embodiments in the specification to be strictly coextensive.” Phillips v. AHW Corp., 415 F.3d 1303, 1323 (Fed. Cir. 2005) (en bane).

1. An emergency alert system (10) comprising:
a card (15) comprising:
an activation button (55);
a Bluetooth transmitter (60) configured to transmit a beacon (12), wherein the beacon comprises (1) a unique identification for the card and (2) a current card state;
a controller (65) connected to the button and transmitter, wherein the controller is configured to perform the following steps:
transmit a beacon identifying the current state as normal when the activation button is not actuated; and
transmit a beacon identifying the current state as emergency when the activation button is actuated;
a device (20, 25) comprising:
a Bluetooth receiver (80) configured to receive the beacon;
a communications port (85);
a device controller connected to the Bluetooth receiver and communications port, wherein the device controller is configured to perform the following steps:
receive and process the beacon;
transmit an emergency signal (30, 32) on the communications port when the beacon is in an emergency state; and
a central server (35) connected to the communications port and configured to receive the emergency signal.

2. The emergency alert system of claim 1, wherein the card comprises an illumination device (70), wherein the illumination device is actuated when the activation button is actuated.

3. The emergency alert system of claim 1, wherein the activation button is actuated by either pressing the button for longer than five seconds or pressing the button five or more times within four seconds.

4. The emergency alert system of claim 1, wherein the device comprises one or more cellular phones (20), and the communications port for the one or more cellular phones is wireless (30).

5. The emergency alert system of claim 4, the cellular phone comprising an emergency application that allows a user to select a type of emergency, and wherein the device controller is configured to perform the following steps:
open the emergency application when the beacon is in an emergency state;
receive the input from the user selecting the type of emergency; and
wherein the emergency signal further comprises the type of emergency selected by the user.

6. The emergency alert system of claim 5, wherein the application automatically indicates the type of emergency as police if the user does not select the type of emergency within a pre-selected time period.

7. The emergency alert system of claim 5, wherein the application allows the user to select from the following emergencies: police, fire, medical, chemical leak, and, vehicular crash.

8. The emergency alert system of claim 4, wherein the device controller is configured to perform the following step:
determine the location of the cellular phone;
wherein the emergency signal further comprises the location of the cellular phone.

9. The emergency alert system of claim 4, wherein
the central server transmits to the cellular phone a confirmation signal that the emergency signal has been received;
a display or speaker of the cellular device is triggered based on the confirmation signal.

10. The emergency alert system of claim 9, wherein upon receipt of the confirmation signal, the cellular phone opens a dialog session with the central server.

11. The emergency alert system of claim 1, wherein the device comprises one or more Bluetooth readers (25) that are relatively fixed to a particular location and have unique identifiers.

12. The emergency alert system of claim 11, wherein the location of the one or more Bluetooth readers and their associated unique identifiers are stored within the system; and wherein the emergency signal includes the Bluetooth reader's unique identifier and the central server looks up the location of the Bluetooth reader's unique identifier.

13. The emergency alert system of claim 2, wherein the card comprises a housing (75) that houses the activation button, the Bluetooth transmitter, the controller and the illumination device.

14. The emergency alert system of claim 1, wherein the beacon comprises a battery state and wherein the device comprises a display or a sound device, and the device controller is configured to perform the following steps:
actuate the display or sound device when the beacon is in a low battery state.

15. A method of operating an emergency alert system comprising a card having a Bluetooth transmitter, a device having a Bluetooth receiver and a communications port, and a central server connected to the communications port, the method comprising the following steps:
operating a device to listen for a Bluetooth beacon transmitted by the card;
if the device receives an emergency state Bluetooth beacon transmitted by the card, operating the device to transmit an emergency signal to the central server on the communications port; and
transmitting the emergency signal to the central server until a confirmation signal has been received on the communications port of the device.

16. The method of claim 15, wherein the emergency signal transmitted from the device to the server includes a unique identifier for the device.

17. The method of claim 15, wherein the emergency signal transmitted from the device to the server includes location data and timestamp for the device.

18. The method of claim 15, the method further comprising the following step:
actuating an application on the device to prompt a user of the card to select at least one emergency type; and
operating the device to transmit an emergency type in the emergency signal transmitted from the device to the server.

19. The method of claim 18, wherein if the user has not used the application on the device to select at least one emergency type, the device transmits a default emergency type in the emergency signal transmitted from the device to the server.

20. The method of claim 15, wherein the method further comprises the step of:
initiating a dialog session between the device and the central server.
